(19) United States
(12) Patent Application Publication
(10) Pub. No.: US 2025/0392834 A1
(43) Pub. Date: Dec. 25, 2025

(54) CONTROL METHOD, OPTICAL COMMUNICATION SYSTEM, AND STORAGE MEDIUM

(71) Applicant: CASIO COMPUTER CO., LTD., Tokyo (JP)

(72) Inventors: Naotomo MIYAMOTO, Tokyo (JP); Nobuo IIZUKA, Tokyo (JP); Masaaki KIKUCHI, Tokyo (JP); Taichi MURAKAMI, Tokyo (JP)

(73) Assignee: CASIO COMPUTER CO., LTD., Tokyo (JP)

(21) Appl. No.: 19/235,399

(22) Filed: Jun. 11, 2025

(30) Foreign Application Priority Data
Jun. 21, 2024 (JP) 2024-100547

(51) Int. Cl. H04N 25/40; H04N 25/13

(52) U.S. Cl. CPC H04N 25/40; H04N 25/134

(57) ABSTRACT

Disclosed is a control method that is performed by a processor of a receiving apparatus including a receiver including: a color filter in which filter elements corresponding to color components are arranged in a color array; and an imager that has pixels arranged to correspond to the color components, detects, for each of the pixels, a luminance change as an event in response to the change being equal to or more than a threshold value, and in response to detecting the event, outputs an event signal including a position of a pixel where the event has occurred and a polarity of the change. The control method includes: first-obtaining, based on the event signal, color information on the pixel where the change has occurred; second-obtaining, based on temporal change of the color information, a color pattern indicating time-series change of the color information; and decoding the color pattern to obtain information.

### REFERENCE TO RELATED APPLICATIONS

This application is based upon and claims the benefit of priority from the prior Japanese Patent Application No. 2024-100547, filed on Jun. 21, 2024, the entire contents of which are incorporated herein by reference.

### TECHNICAL FIELD

The present disclosure relates to a control method, an optical communication system, and a storage medium.

### DESCRIPTION OF RELATED ART

In JP 2020-36102 A, there is disclosed an optical communication method of generating an optical signal the color of which cyclically changes between colors, and selecting the leading color in each symbol period from among the colors on the basis of transmission data. There is also disclosed a technology of capturing the optical signal with a rolling shutter camera, and obtaining reception data on the basis of the color obtained in each frame at a specific pixel. In this manner, change in the optical signal that appears only at several pixels in the camera is tracked and demodulated

### SUMMARY OF THE INVENTION

According to an aspect of the present disclosure, there is provided a control method that is performed by a processor of a receiving apparatus including a receiver including: a color filter in which filter elements corresponding to color components are arranged in a predetermined color array; and an imager that has pixels arranged to correspond to the color components, detects, for each of the pixels, a luminance change as an event in response to the luminance change being equal to or more than a threshold value, and in response to detecting the event, outputs an event signal including a position of a pixel where the event has occurred and a polarity of the luminance change, the control method including:

first-obtaining, based on the event signal, color information on the pixel where the luminance change has occurred;

second-obtaining, based on temporal change of the color information, a color pattern indicating time-series change of the color information; and

decoding the color pattern to obtain information.

### BRIEF DESCRIPTION OF DRAWINGS

FIG. 1 illustrates an optical communication system according to an embodiment(s).

FIG. 2 illustrates a color filter according to the embodiment.

FIG. 3 illustrates an example of a RAW image and a color image according to the embodiment.

FIG. 4 illustrates another example of the RAW image and the color image according to the embodiment.

FIG. 5 illustrates an event detection process according to the embodiment.

FIG. 6 is a flowchart of a communication process according to the embodiment.

### DETAILED DESCRIPTION

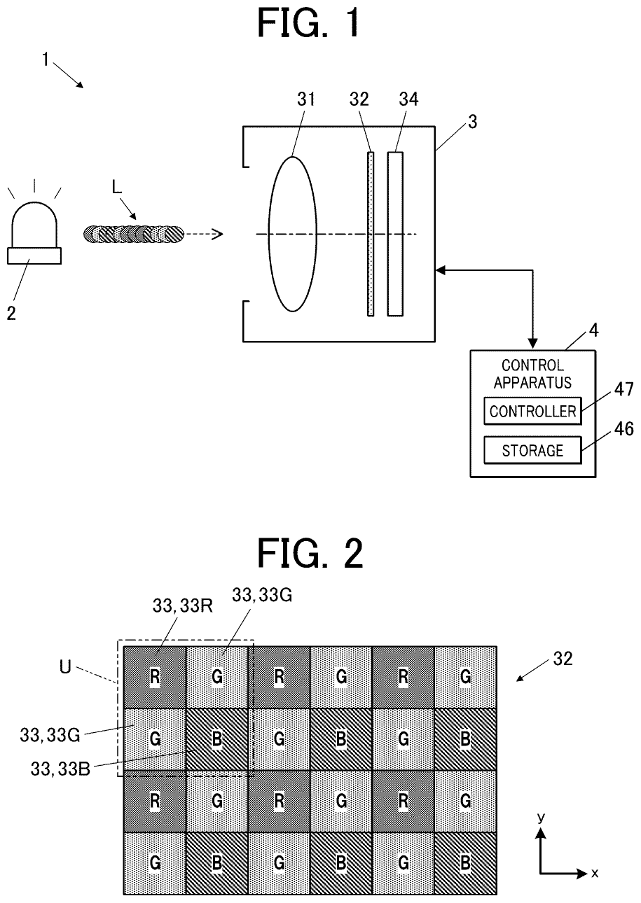

Hereinafter, an embodiment(s) of the present disclosure will be described with reference to the drawings. As illustrated in FIG. 1, an optical communication system 1 according to this embodiment performs information communication using an optical communication method that utilizes change in luminescent color. More specifically, the optical communication system 1 includes a transmitter 2, a receiver 3, and a control apparatus 4. The receiver 3 and the control apparatus 4 constitute a receiving apparatus of the present disclosure.

The transmitter 2 is a light emitting diode (LED) light source capable of emitting light of three colors of red (R), green (G) and blue (B), which hereinafter may be referred to as R light, G light and B light. The transmitter 2 of this embodiment emits any of R light, G light and B light with a predetermined luminance value (e.g., 255 in 8-bit grayscale) at predetermined emission intervals T (e.g., 100 ms, 10 Hz). Thus, the transmitter 2 can emit light with a color pattern L corresponding to communication information to transmit. The transmitter 2 is not particularly limited in type of lightning appliance and emission principles as long as it is capable of emitting light of three colors of red, green and blue. The transmitter 2 may include a controller that controls the color pattern L or the like.

The receiver 3 is, what is called, an event camera having an imaging device that outputs, as event data, information only on a pixel(s) where luminance change has occurred. That is, in an event detection process, which will be described later, the receiver 3 outputs event data by associating data indicating the polarity of luminance change with the position (pixel position) of an imaging pixel(s) that has detected the luminance change and as well as with the time (timestamp). In the receiver 3, light from a subject having passed through an optical system 31 is incident on an imager 34 via a color filter 32. As illustrated in FIG. 2, in the color filter 32, filter elements 33 corresponding to R, G and B components are two-dimensionally arranged on an xy plane to transmit light of wavelengths of R, G and B components in units of pixels. The color filter 32 of this embodiment is, for example, a Bayer RGB filter and has one R pixel, one B pixel and two G pixels arranged at 2×2 pixels of a horizontal (x) and vertical (y) size. The imager 34 is a solid-state image sensor that detects and photoelectrically converts a subject image formed with light having passed through the optical system 31 and the color filter 32. The imager 34 has pixels (pixel sensors) arranged to correspond to the color array of the color filter 32. Each pixel observes one of R light, G light and B light that correspond to the color array of the color filter 32. The receiver 3 may include optical elements, such as various filters, in addition to those mentioned above.

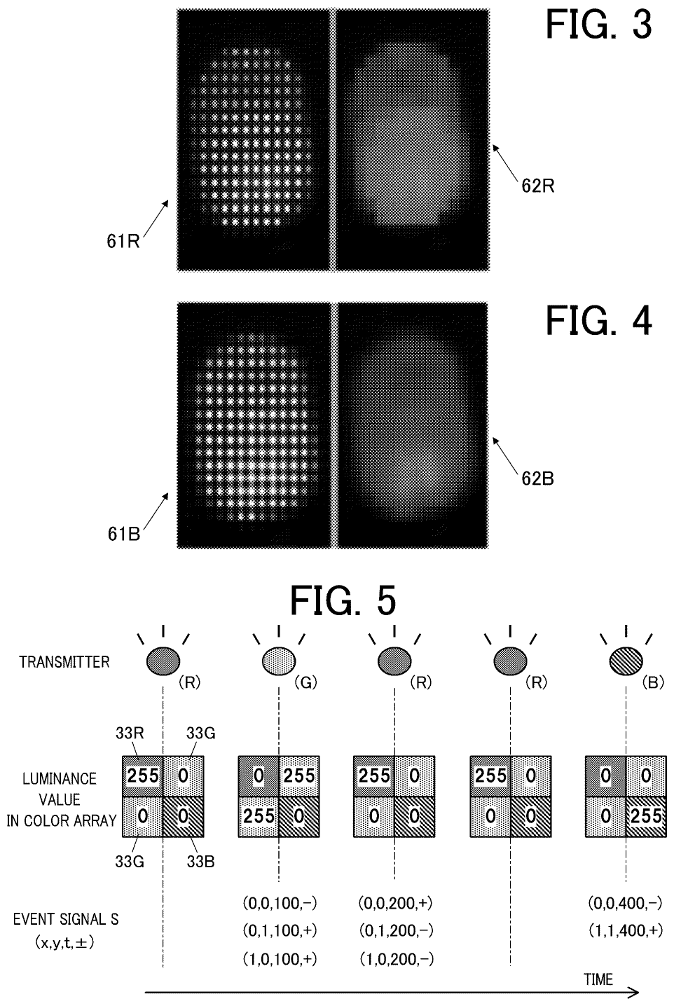

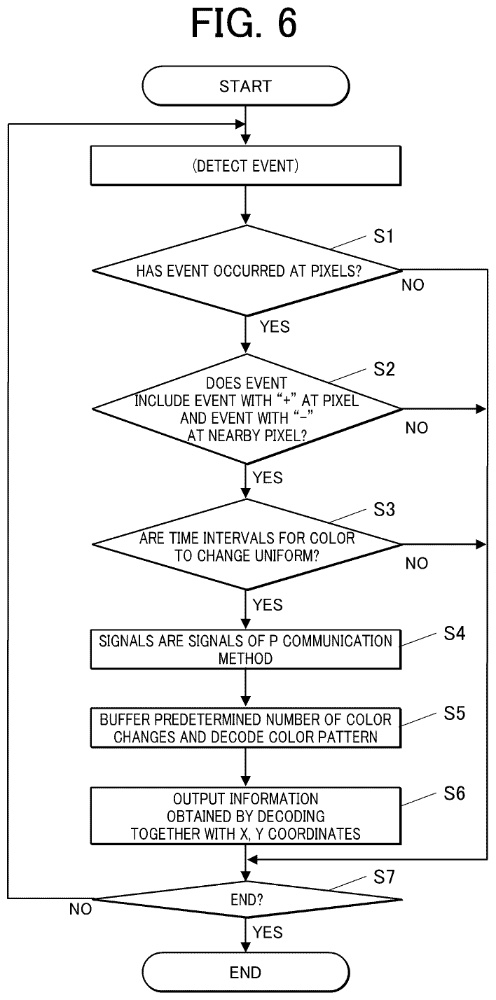

The receiver 3 thus configured obtains an unprocessed RAW image that corresponds to the color array of the color filter 32. For example, if strong red light is incident on the receiver 3, as illustrated in FIG. 3, a RAW image 61R is obtained where luminance values are largest (255 in 8-bit grayscale) at pixels each having x, y coordinate values of odd values among the pixels of the imager 34. By debayering this RAW image 61R, a color image 62R where red appears is obtained. As another example, if strong blue light is incident on the receiver 3, as illustrated in FIG. 4, a RAW image 61B is obtained where luminance values are largest at pixels each having x, y coordinate values of even values among the pixels of the imager 34. By debayering this RAW image 61B, a color image 62B where blue appears is obtained. However, as described later, in a communication process of this embodiment, it is possible to determine color change by obtaining coordinate values of pixels corresponding to the color array of the color filter 32 without debayering or the like to convert an image into a color image.

As illustrated in FIG. 1, the control apparatus 4 is a computer that processes images (image information) obtained by the receiver 3. More specifically, the control apparatus 4 includes a storage 46 and a controller 47 (processor) as well as an operation receiver (not illustrated) that receives user operations and a display (not illustrated) that displays various types of information. The storage 46 is a memory constituted by a random access memory (RAM), a read only memory (ROM) and/or the like, and stores various programs and data, and also serves as a work area for the controller 47. More specifically, the storage 46 stores in advance, for example, a program for the communication process, which will be described later, and data for decoding. The controller 47 is constituted, for example, by a central processing unit (CPU) and/or the like, and controls operation of each component of the control apparatus 4. For example, the controller 47 loads the programs stored in advance in the storage 46 and performs various processes in cooperation with the loaded programs.

Next, the event detection process that is performed by the receiver 3 of this embodiment will be described. For the sake of simplicity, description will be made as to only four pixels corresponding to a single color array unit U (enclosed by a dash-double-dot line in FIG. 2). The receiver 3 is, what is called, an event camera, and for each pixel of the imager 34, if luminance change is equal to or more than a predetermined threshold value, detects this as an event. The threshold value is not limited to, but, for example, about 200 in 8-bit grayscale. The receiver 3 asynchronously outputs the x, y coordinate values, time and (light/dark) polarity of each pixel that has detected the event to the control apparatus 4 as an event signal S of (x, y, t, +/−), namely, asynchronously outputs event signals S.

As illustrated in FIG. 5, in the initial state, the transmitter 2 emits red (R) light as an example. No event signals S are output at the time because there is no luminance change at any pixels. Next, if the transmitter 2 emits green (G) light, event signals S of (0, 0, 100, −), (0, 1, 100, +) and (1, 0, 100, +) are output from three pixels where luminance change is equal to or more than a threshold value. The unit of t, which represents the time, is [ms]. Strictly speaking, however, these event signals S are output with infinitesimal time differences. Next, if the transmitter 2 emits red (R) light, event signals S of (0, 0, 200, +), (0, 1, 200, −) and (1, 0, 200, −) are output. Next, the transmitter 2 keeps emitting red (R) light. Since there is no luminance change at any pixels, no event signals S are output. Next, if the transmitter 2 emits blue (B) light, event signals S of (0, 0, 400, −) and (1, 1, 400, +) are output. Thus, the receiver 3 outputs data of only pixels at each of which the luminance value (pixel value) has changed. This can reduce the amount of data and achieve a high frame rate.

Next, the communication process that is performed by the control apparatus 4 will be described. In the communication process, it is determined whether event signals S from the receiver 3 are signals of a predetermined communication method (hereinafter “P communication method”) used by the optical communication system 1, and if it is determined that they are signals of the P communication method, decoding and so forth are performed. The P communication method uses a signal in which predetermined communication information is associated with the color pattern L (in which the same color may continue) that indicates time-series change of pieces (e.g., 24 pieces) of color information. The communication information is not particularly limited to, but, for example, ID information or the like that identifies the transmitter 2. This communication process is performed by the controller 47 reading and loading the program for the communication process from the storage 46, for example, on the basis of an execution operation or the like made by a user. In this embodiment, the transmitter 2 switches, on the basis of a predetermined emission command, the color of light to emit between R, G and B at emission intervals T, and the receiver 3 that receives the light performs the event detection process described above. In this embodiment, the transmitter 2 is fixed.

When the event detection process is performed by the receiver 3 and event signal(s) S are input to the control apparatus 4, the controller 47 first determines whether the event has occurred at two or more pixels in an area in the angle of view of the receiver 3, which is a camera (Step S1). That is, the controller 47 determines whether event signals S have been output from two or more pixels. If the controller 47 determines that the event has not occurred at two or more pixels (Step S1; No), the controller 47 advances the process to Step S7.

If the controller 47 determines in Step S1 that the event has occurred at two or more pixels (Step S1; Yes), the controller 47 determines whether the event includes an event with “+” as the polarity of the luminance change at any of the pixels and an event with “−” as the polarity of the luminance change at a nearby pixel (Step S2). That is, the control apparatus 4 determines on the basis of the event signals S whether pixels corresponding to color components in a single/same color array unit U include (at least two) pixels different in polarity of the luminance change. If the controller 47 determines that the event does not include such events (Step S2; No), the controller 47 advances the process to Step S7. In this embodiment, the “nearby pixel” is, among the pixels of the same color array (color array unit U, to be specific) (Bayer array in this embodiment), any pixel other than the pixel with “+” as the polarity. That is, the determination in this step is determination as to whether the color, which is observed by the imager 34, has been switched.

If the controller 47 determines in Step S2 that the event includes an event with “+” as the polarity at any of the pixels and an event with “−” as the polarity at a nearby pixel (Step S2; Yes), the controller 47 determines whether time intervals for the color to change are uniform (Step S3). That is, the controller 47 determines whether the timing of color change comes at regular time intervals. If the controller 47 determines that the time intervals for the color to change are not uniform (Step S3; No), the controller 47 advances the process to Step S7.

If the controller 47 determines in Step S3 that the time intervals for the color to change are uniform (Step S3; Yes), the controller 47 determines that the received event signals S are signals of a predetermined communication method (P communication method) (Step S4). That is, in Step S1 to Step S4, if (i) the event occurs at two or more pixels, (ii) these pixels include a pixel with “+” as the polarity and a nearby pixel with “−” as the polarity, and (iii) the time intervals for the color to change are uniform, the received event signals S are determined as signals of the P communication method.

Next, the controller 47 buffers a predetermined number of color changes in the time direction and decodes the obtained color pattern L (Step S5). More specifically, the controller 47 buffers the color information input from the receiver 3 for a time length of, for example, 24 pieces of the color information (100 ms×24=2.4 s), thereby obtaining the color pattern L (in which the same color may continue) that indicates the time-series change of the 24 pieces of the color information. Then, the controller 47 decodes the obtained color pattern L on the basis of the data for decoding to obtain the communication information. The data for decoding is data in which the color pattern L is associated with the communication information, and stored in the storage 46 in advance.

Next, the controller 47 stores, in the storage 46, the communication information obtained from the color pattern L in Step S5 and the x, y coordinate values of the pixels in the angle of view, the pixels each having detected emission with the color pattern as the event, and outputs these to a predetermined output destination (Step S6).

Next, the controller 47 determines whether to end the communication process (Step S7). If the controller 47 determines not to end the communication process (Step S7; No), the controller 47 returns the process to Step S1. If the controller 47 determines to end the communication process, for example, on the basis of an end operation or the like made by the user (Step S7; Yes), the controller 47 ends the communication process.

As described above, according to this embodiment, the receiver 3 includes the color filter 32 in which the filter elements 33 corresponding to the color components are arranged in a predetermined color array, and the imager 34 having pixels arranged to correspond to the color components. The control apparatus 4 obtains, on the basis of an event signal(s) S output from the imager 34, the color information on a pixel(s) where the luminance change has occurred, obtains the color pattern L on the basis of temporal change of the color information, and decodes this color pattern L to obtain information (e.g., communication information). That is, by obtaining the values of the pixels of the imager 34 corresponding to the color array of the color filter 32, it is possible to obtain information on color change without debayering or the like to convert an image into a color image. Thus, conversion of a group of images captured at a high frame rate can be appropriately coped with. Therefore, faster communication can be achieved as compared with a conventional technology in which the frame rate is fixed. By extension, luminescent colors can be switched at a high speed at which the switching is hardly recognized with human eyes.

Furthermore, according to this embodiment, optical signals can be received simultaneously from transmitters 2 having different color change cycles. A conventional frame-based camera has a fixed image obtaining cycle, and can receive an optical signal(s) only from a transmitter(s) having a color change cycle corresponding to the fixed image obtaining cycle. In this regard, according to this embodiment, because the receiver 3 can obtain signals asynchronously, this single receiver 3 can simultaneously receive optical signals from transmitters 2 that transmit optical signals different in cycle.

Furthermore, according to this embodiment, the imager 34 detects, for each of its pixels, luminance change as an event in response to the luminance change being equal to or more than a threshold value, and in response to detecting the event, outputs an event signal(s) S as the color information. By setting a large threshold value, small noise or the like is hardly picked up, and only a desired optical signal(s) can be appropriately obtained.

Furthermore, according to this embodiment, in Step S2 of the communication process, the controller 47 determines whether the pixels corresponding to the color components in the color array, to be specific, pixels corresponding to color components in a single/same color array unit U of the color array, include at least two pixels different in polarity of the luminance change. If the controller 47 determines in Step S2 that the pixels include at least two pixels different in polarity of the luminance change, the controller 47 obtains the color pattern L. That is, after it is confirmed in Step S2 that the obtained signals are signals of the P communication method to be communicated, the color pattern L is obtained. Thus, communication-target signals can be identified automatically and processed. By extension, non-communication-target signals are not subjected to buffering, decoding and/or the like, and accordingly the communication process can be performed efficiently.

Furthermore, according to this embodiment, in Step S2 of the communication process, if the controller 47 determines that the pixels include at least two pixels different in polarity of the luminance change, the controller 47 determines in Step S3 whether the time intervals for the color to change are uniform. If the controller 47 determines in Step S3 that the time intervals for the color to change are uniform, the controller 47 obtains the color pattern L. That is, after it is confirmed with higher reliability in Step S3 that the obtained signals are signals of the P communication method to be communicated, the color pattern L is obtained. Thus, the accuracy of identification of the communication-target signals can be improved, and accordingly the communication process can be performed more efficiently.

Furthermore, according to this embodiment, the controller 47 stores, in the storage 46, the communication information obtained from the color pattern L and the position(s) (coordinates) of the pixel(s) where the event has occurred. Thus, desired information can be retained without the image information being stored, and accordingly the capacity of the storage 46 can be used efficiently.

Furthermore, according to this embodiment, faster communication can be achieved as compared with a conventional technology that (i) can hardly read an optical signal of a light source that changes pixels at a high speed and (ii) has inferior responsibility to high-speed color change since in the conventional technology, the frame rate is fixed when the optical signal is obtained.

It goes without saying that embodiments to which the present disclosure is applicable are not limited to the above embodiment, and various mortifications can be made within the range of not departing from the scope of the present disclosure. For example, in the above embodiment, the transmitter 2 is fixed and immobile. However, in the communication process, the controller 47 may determine that the transmitter 2 (light source) has moved if a pixel(s) of the (at least two) pixels that have been detecting (outputting) the event (events different in polarity of the luminance change) at predetermined time intervals does not output the event. That is, if the transmitter 2 moves, temporal change of the polarity becomes inconsistent around the pixels that have been detecting the event as communication-target signals. This phenomenon may be detected. In this case, the control apparatus 4 may output a notification that the transmitter 2 has moved.

Furthermore, the color filter 32 may have a layered structure in which the filter elements 33 corresponding to the color components are arranged at different layers. Although not particularly limited, the color filter 32 may have, for the respective wavelengths of light, a first layer for blue, a second layer for green and a third layer for red to transmit blue light, green light and red light individually. This makes it possible to more clearly distinguish these three colors from one another at the time of color determination. Furthermore, the color array of the color filter 32 is not limited to the Bayer array. Various color arrays are applicable to the color array of the color filter 32.

Furthermore, the optical communication system 1 can be put to various uses. For example, the optical communication system 1 can be used as a system that obtains, as the communication information, position information on a cargo-handling vehicle, such as a forklift, by the transmitter 2 being installed in the cargo-handling vehicle and the receiver 3 and the control apparatus 4 being installed in a facility or the like. Furthermore, the optical communication system 1 can be used in any optical-signal-usable environment, and can be appropriately used, for example, in an environment where radio wave communication is limited, in particular.

1. A control method that is performed by a processor of a receiving apparatus including a receiver including: a color filter in which filter elements corresponding to color components are arranged in a predetermined color array; and an imager that has pixels arranged to correspond to the color components, detects, for each of the pixels, a luminance change as an event in response to the luminance change being equal to or more than a threshold value, and in response to detecting the event, outputs an event signal including a position of a pixel where the event has occurred and a polarity of the luminance change, the control method comprising:
first-obtaining, based on the event signal, color information on the pixel where the luminance change has occurred;
second-obtaining, based on temporal change of the color information, a color pattern indicating time-series change of the color information; and
decoding the color pattern to obtain information.

2. The control method according to claim 1, wherein in the first-obtaining, the processor determines based on the event signal whether the pixels corresponding to the color components in the color array include at least two pixels different in the polarity of the luminance change, and
wherein in the second-obtaining, the processor obtains the color pattern in response to determining in the first-obtaining that the pixels corresponding to the color components include at least two pixels different in the polarity of the luminance change.

3. The control method according to claim 2, wherein in the first-obtaining, in response to determining that the pixels corresponding to the color components include at least two pixels different in the polarity of the luminance change, the processor determines whether time intervals for the color information to change are uniform, and
wherein in the second-obtaining, the processor obtains the color pattern in response to determining in the first-obtaining that the time intervals for the color information to change are uniform.

4. The control method according to claim 2, wherein in the decoding, the processor stores, in a storage, the information obtained from the color pattern and the position of the pixel where the event has occurred.

5. The control method according to claim 1, wherein the predetermined color array is a Bayer array.

6. The control method according to claim 2, wherein the first-obtaining includes determining that a light source has moved, in response to, of the at least two pixels that have been outputting the event at predetermined time intervals, a pixel not outputting the event.

7. The control method according to claim 2, wherein in the color filter, the filter elements corresponding to the color components are arranged at different layers.

8. An optical communication system comprising:
a transmitter that emits any of color components at predetermined emission intervals;
a receiver including:
a color filter in which filter elements corresponding to the color components are arranged in a predetermined color array; and
an imager having pixels arranged to correspond to the color components; and
a control apparatus,
wherein the imager detects, for each of the pixels, a luminance change as an event in response to the luminance change being equal to or more than a threshold value, and
in response to detecting the event, outputs an event signal including a position of a pixel where the event has occurred and a polarity of the luminance change, and
wherein the control apparatus
obtains, based on the event signal, color information on the pixel where the luminance change has occurred,
obtains, based on temporal change of the color information, a color pattern indicating time-series change of the color information, and
decodes the color pattern to obtain information.

9. The optical communication system according to claim 8, wherein the control apparatus
determines based on the event signal whether the pixels corresponding to the color components in the color array include at least two pixels different in the polarity of the luminance change, and
obtains the color pattern in response to determining that the pixels corresponding to the color components include at least two pixels different in the polarity of the luminance change.

10. The optical communication system according to claim 9, wherein the control apparatus in response to determining that the pixels corresponding to the color components include at least two pixels different in the polarity of the luminance change, determines whether time intervals for the color information to change are uniform, and
obtains the color pattern in response to determining that the time intervals for the color information to change are uniform.

11. A non-transitory computer-readable storage medium storing a control program that causes, of a receiving apparatus including a receiver including: a color filter in which filter elements corresponding to color components are arranged in a predetermined color array; and an imager that has pixels arranged to correspond to the color components, detects, for each of the pixels, a luminance change as an event in response to the luminance change being equal to or more than a threshold value, and outputs an event signal including a position of a pixel where the event has occurred and a polarity of the luminance change, a computer to:
obtain, based on the event signal, color information on the pixel where the luminance change has occurred;
obtain, based on temporal change of the color information, a color pattern indicating time-series change of the color information; and
decode the color pattern to obtain information.
